(19) United States
(12) Patent Application Publication
(10) Pub. No.: US 2015/0149235 A1
(43) Pub. Date: May 28, 2015

(54) METHODS AND SYSTEMS TO IMPROVE A QUALITY OF DATA EMPLOYED BY A HEALTHCARE ANALYTICS SYSTEM

(71) Applicant: General Electric Company, Schenectady, NY (US)

(72) Inventor: George William Leung, Hillsboro, OR (US)

(73) Assignee: General Electric Company, Schenectady, NY (US)

(21) Appl. No.: 14/092,628

(22) Filed: Nov. 27, 2013

(51) Int. Cl. G06Q 10/06; G06Q 50/22

(52) U.S. Cl. CPC G06Q 10/0633; G06Q 10/06395; G06Q 50/22
USPC 705/7.27

(57) ABSTRACT

An example method disclosed herein includes receiving a data submission in a healthcare analytics system. The healthcare analytics system is to generate an analytic solution based on the data submission. The example method also includes determining, by the healthcare analytics system, an opportunity to improve a quality of data to be employed by the healthcare analytics system to generate the analytic solution based on a trend of previously received data submissions and the data submission. The example method further includes generating an alert including a recommended change to at least one of a characteristic of the data submission or a portion of a workflow of the healthcare analytics system based on the opportunity.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Healthcare facilities such as hospitals and clinics often employ healthcare analytics systems to ingest data submissions and generate analytic solutions such as medical reports or billing reports. A plurality of data sources may input data submissions in a variety of different ways. As a result, analytic solutions generated based on these data submissions may be inaccurate or inconsistent. However, a user of the analytic solution and/or a system employing the analytic solution may be unable to determine if inaccuracies or inconsistencies in the analytic solutions are a result of a workflow used to generate the analytic solutions or the data submissions.

### SUMMARY

An example method disclosed herein includes receiving a data submission in a healthcare analytics system. The healthcare analytics system is to generate an analytic solution based on the data submission. The example method also includes determining, by the healthcare analytics system, an opportunity to improve a quality of data to be employed by the healthcare analytics system to generate the analytic solution based on a trend of previously received data submissions and the data submission. The example method further includes generating an alert including a recommended change to at least one of a characteristic of the data submission or a portion of a workflow of the healthcare analytics system based on the opportunity.

Another example method disclosed herein includes monitoring data submissions received by a healthcare analytics system. The healthcare analytics system is to generate an analytic solution based on the data submissions. The example method also includes determining a trend of the data submissions and receiving a data submission via the healthcare analytics system. The example method further includes comparing the data submission to the trend and generating an alert if the data submission deviates from the trend in a predetermined way. The alert includes a recommended change to a characteristic of subsequent data submissions.

Another example method disclosed herein includes monitoring data submissions ingested by a healthcare analytics system. The healthcare analytics system is to generate an analytic solution based on the data submissions. The example method also includes determining a quality indicator based on the data submissions and generating a trend of the quality indicator of the data submissions. The example method further includes receiving a data submission and determining if the data submission deviates from the trend in a predetermined way. The example method also includes generating an alert if the data submission deviates from the trend in a predetermined way. The alert includes at least one of a first recommendation to enable subsequent data submissions to substantially correspond to the trend or a second recommendation to adjust a portion of a workflow of the healthcare analytics system.

### BRIEF DESCRIPTION OF SEVERAL VIEWS OF THE DRAWINGS

FIG. 1 is a block diagram of an example medical information system disclosed herein.

FIG. 2 is a block diagram of an example interface unit and an example healthcare analytics system of the example medical information system of FIG. 1.

FIG. 3 is a block diagram of an example data quality determiner of the example healthcare analytics system of FIG. 2.

FIGS. 4-5 illustrate a flow diagram of an example method to improve a quality of data employed to generate an analytic solution.

FIG. 6 is a block diagram of an example processor platform that may be used to implement the example systems and methods disclosed herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

Methods and systems to improve a quality of data employed by a healthcare analytics system are disclosed herein. An example healthcare analytics system disclosed and described herein receives and ingests data submissions and generates analytic solutions (e.g., medical reports, billing reports, and/or any other type of analytic solution) based on the data submissions. The example healthcare analytics system may receive the data submissions from one or more data source. Example data sources may include user workstations, information systems, and/or any other data source, and the data sources may be associated with respective identifications or credentials. For example, a user workstation may be associated with a clinician, a group of clinicians, a healthcare center, etc.

In some examples, the healthcare analytic system monitors one or more characteristics of the data submissions. For example, the healthcare analytics system may monitor format, file type, content, style and/or other characteristics of data submissions. In some examples, the healthcare analytics system monitors characteristics associated with standards compliance, completeness, validity, accuracy, business rules, consistency, continuity, duplication, integrity, and/or other characteristics. The healthcare analytics system may generate a trend based on a monitored characteristic. For example, the healthcare analytics system may generate a trend based on a statistical analysis of the monitored characteristic. In some examples, the trend includes a trendline such as a range of values.

Once the trend is generated, the healthcare analytics system compares data submissions to the trend to determine if the data submission deviates from the trend in a predetermined way. For example, the healthcare analytics system may determine if a value included in the data submission is outside of the range of values corresponding to the trendline. If the data submission deviates from the trend in the predetermined way, the healthcare analytics system determines an opportunity to improve a quality of data to be employed by the healthcare analytics system to generate analytic solutions. In some examples, the healthcare analytics system determines that the opportunity is a change in a characteristic of subsequent data submissions. The healthcare analytics system may then generate an alert identifying the data source and/or recommending the change, and a user associated with the data source may implement the change when inputting subsequent data submissions. In some examples, the healthcare analytics system determines that the opportunity is a change in a workflow of the healthcare analytics system used to generate the analytic solution. In some examples, the healthcare analytics system enables a user to model and simulate a model workflow including the change. For example, the system may enable the user to view and/or evaluate an analytic solution generated using the model workflow without interrupting or disrupting the healthcare analytics system. Thus, the user may preview an effect of the recommended change on the analytic solution.

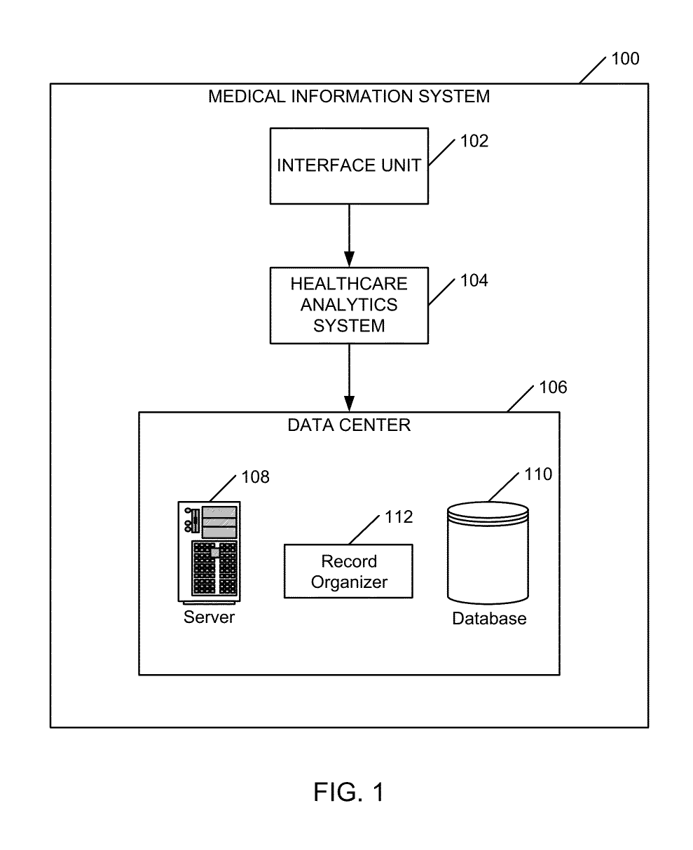

FIG. 1 illustrates an example medical information system 100. In the illustrated example, the medical information system 100 includes an interface unit 102, a healthcare analytics system 104 and a data center 106. In other examples, the medical information system 100 is implemented in other ways. The example interface unit 102 of FIG. 1 facilitates submissions of data into the example medical information system 100. For example, the interface unit 102 may include and/or be in communication with one or more user workstations, information systems (e.g., a hospital information system, a radiology information system, a picture archiving and communication system (PACS), networks (e.g., the internet), medical devices and/or equipment, and/or other data sources. In some examples, the interface unit 102 generates one or more dashboards though which data is submitted. The dashboards may organize a flow of data submitted, limit or restrict types of information submitted, etc.

The example healthcare analytics system 104 of FIG. 1 ingests data submissions and generates analytic solutions such as, for example, medical reports, billing reports, and/or any other analytic solution(s). The example data center 106 organizes and/or stores the analytic solutions and/or other data. In some examples, the data center 106 provides access to the analytic solutions and/or other data stored in the data center 106. In the illustrated example, the data center 106 includes a server 108, a database 110 and a record organizer 112. The example server 108 receives, processes and/or conveys the analytic solutions and/or other data to components of the example healthcare information system 100. The example database 110 stores the analytic solution and/or other data, and the example record organizer 112 organizes the analytic solutions and/or other data.

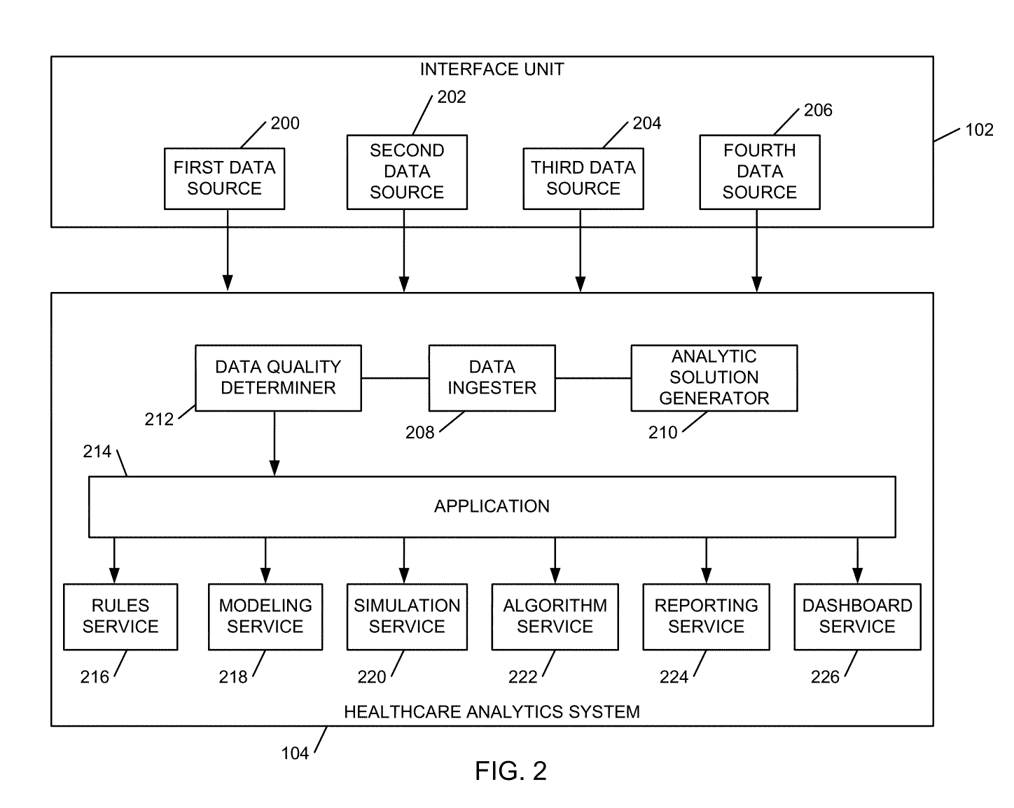

FIG. 2 illustrates the example healthcare analytics system 104 of FIG. 1. In the illustrated example, the healthcare analytics system 104 receives data submissions from a plurality of data sources 200, 202, 204, 206. In some examples, the data sources 200, 202, 204, 206 are users, information systems, medical devices and/or equipment, and/or other data sources. For example, the first data source 200 may be a first user workstation, the second data source 202 may be a second user workstation, the third data source 204 may be a medical device, and the fourth data source may be a PACS. In the illustrated example, the healthcare analytics system 104 includes a data ingester 208. The example data ingester 208 ingests the data submissions by, for example, filtering portions of the data submissions, formatting portions the data submissions, and/or performing other actions. An analytic solution generator 210 of the example healthcare analytics system 104 may generate one or more analytic reports based on the data submitted by the first data source 200, the second data source 202, the third data source 204, the fourth data source 206 and/or other data sources. For example, the analytic solution generator 210 may generate a medical report based on a first data submission from the first data source 200 and/or a second data submission from the second data source 202.

The example healthcare analytics system 104 of FIG. 2 includes a data quality determiner 212 that determines opportunities to improve a quality of data employed by the healthcare analytics system 104 to generate an analytic solution. The example healthcare analytics system 104 of FIG. 2 includes an application 214 to facilitate improvements in a workflow of the example healthcare analytics system 104 based on the opportunities determined via the data quality determiner 212. In some examples, the application 214 cooperates with the data quality determiner 212 to determine the opportunities. In some examples, the application 214 employs one or more analytic services to determine the opportunities and/or facilitate improvements in the workflow. For example, the example application 214 of FIG. 2 employs a rules service 216, a modeling service 218, a simulation service 220, an algorithm service 222, a reporting service 224 and a dashboard service 226. Other examples employ different and/or additional services. As described in greater detail below, the application 214 enables changes to the workflow to be modeled, simulated and/or evaluated.

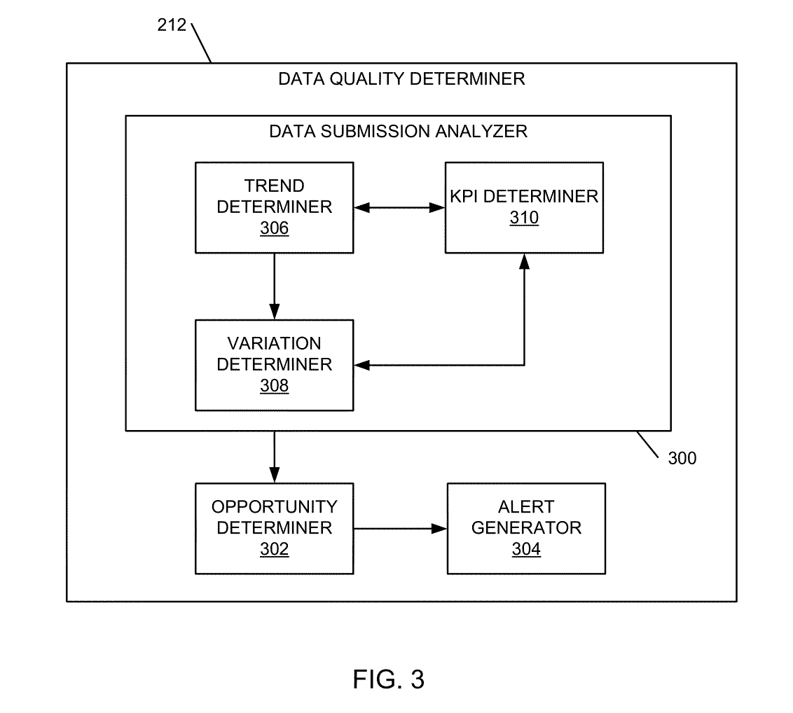

FIG. 3 is block diagram of the example data quality determiner 212 of FIG. 2. In the illustrated example, the data quality determiner 212 includes a data submission analyzer 300, an opportunity determiner 302, and an alert generator 304. The example data submission analyzer 300 includes a trend determiner 306, a variation determiner 308, and a key parameter indicator (KPI) determiner 310.

The example data submission analyzer 300 monitors data submissions received and/or ingested by the example healthcare analytics system 104, and the example opportunity determiner 302 determines opportunities to improve a quality of data to be employed by the healthcare analytics system 104 to generate an analytic solution. For example, the trend determiner 306 may monitor the data submissions and determine one or more trends of the data submissions. In some examples, the variation determiner 308 detects a variation or deviation of a characteristic of a data submission relative to a trend. If the characteristic deviates from the trend(s) in a predetermined way, the opportunity determiner 302 may determine an opportunity to improve a quality of data to be employed by the healthcare analytic system 104 to generate subsequent analytic solutions. For example, the opportunity determiner 302 may determine that a change or adjustment to subsequent data submissions may enable the healthcare analytics system 104 to generate the analytic solutions using data of a higher quality. As a result, the healthcare analytics system 104 may generate the analytic solutions more efficiently, using less information or data, in less time, with increased consistency, with increased accuracy, in fewer steps, etc. As described in greater detail below, in some examples, the opportunity determiner determines an adjustment or change in a workflow of the healthcare analytic system 104 based on the variation to enable the healthcare analytics system 104 to improve a quality of data employed to generate analytic solutions.

In some examples, the trend determiner 306 monitors (e.g., logs) one or more characteristics of the data submissions to determine the trend(s). Example characteristics may include format, file type, content, style and/or other characteristics. For example, if the data submissions include blood pressure readings, the trend determiner 306 may monitor pressure values; if the data submissions include words, the trend determiner may monitor capitalization of the words, numbers of words in each data submission, etc.; if the data submissions includes files (e.g., image files), the trend determiner may monitor file types, file sizes, etc. In some examples, the trend determiner 306 monitors and/or trends characteristics associated with standards compliance, completeness, validity, accuracy, business rules, consistency, continuity, duplication, integrity, and/or other characteristics.

In some examples, the KPI determiner 310 determines which characteristics of the data submissions the trend determiner 306 is to monitor. In some examples, the characteristics determined to be trended are referred to as key parameter indicators or quality indicators. For example, the KPI determiner may determine which characteristics to monitor and/or trend by comparing data submissions received by the healthcare analytic system 104 with data ingested and/or used by the healthcare analytic system 104 to generate analytic solutions. For example, if data ingester 208 filters portions of information from a plurality of data submissions and/or formats portions of a plurality of data submissions to enable the analytic solution generator 210 to generate one or more analytic solutions, the trend determiner 306 may determine and monitor one or more characteristics of the data submissions that causes or triggers the data ingester 208 to filter and/or format the data submissions. For example, if the data ingester 208 discards words that have only lowercase letters, the KPI determiner 310 may determine that capitalization is to be monitored by the trend determiner 306. In some examples, the KPI determiner 310 employs statistical process control and capability analysis to determine which characteristics of the data submissions the trend determiner 306 is to monitor. In some examples, the KPI determiner 310 revisits and/or changes which characteristics the trend determiner 306 is to monitor based on changes in the data submissions, the analytic solutions and/or input via a user or operator of the example healthcare analytics system 104.

Thus, the example healthcare analytic system 104 and/or a systems administrator or operator may adjust, change and/or refine which characteristics are monitored based on information and/or knowledge acquired by the healthcare analytic system 104 and/or the systems administrator so that the healthcare analytic system 104 focuses on characteristics that are most impactful. In some examples, the healthcare analytics system 104 adapts and/or reacts to changing conditions and/or to actions or behavior of the systems administrator related to the healthcare analytics system 104 to monitor and trend characteristics that impact a goal and/or objective of the systems administrator and/or a user of analytic solutions generated via the healthcare analytics system 104. For example, the healthcare analytics system 104 may be configured to analyze data submissions to generate analytic solutions that detect patients having high blood pressure. The example KPI determiner 310 may determine that blood pressure value is a characteristic to be monitored and trended. After monitoring data submissions and/or behavior of the systems administrator and/or user of the healthcare analytics system 104 with respect to the data submissions and/or the analytic solutions, the healthcare analytics system 104 may determine that an objective and/or goal of the user and/or the analytic solutions is to detect patients suffering from hypertension. As a result, the KPI determiner 310 may determine that characteristics that facilitate detection or identification of hypertension are to be monitored in addition to blood pressure values. Other examples may adjust, change and/or refine which characteristics are monitored in other ways.

The example trend determiner 306 may then determine a trend of the characteristic. For example, the trend determiner 306 may trend capitalization of words in data submissions, values of biological measurements (e.g., blood pressures), and/or other characteristics of data submissions. In some examples, when a subsequent data submission is received by the example healthcare analytic system 104, the variation determiner 308 compares the subsequent data submission to the trend. For example, the variation determiner 308 may compare the capitalization of words in previous data submissions to capitalization of words in the subsequent data submission to determine variations and/or deviations of the subsequent data submission from the previous data submissions. If the subsequent data submission deviates or varies in a predetermined way, the example opportunity determiner 302 determines if an opportunity to improve a quality of data to be employed by the healthcare analytic system 104 to generate analytic solutions. For example, if a data submission includes a value of a biological measurement in a first unit of measurement (e.g., pounds per square inch) different than a second unit of measurement (e.g., bars) employed by a majority of previous data submissions, the opportunity determiner 302 may determine that values included in subsequent data submissions could use the second unit measurement to enable the healthcare analytics system 104 to generate analytic solutions without performing a unit conversion. In another example, the opportunity determiner 302 may determine that formatting (e.g., capitalizing) a portion of the data submission in a given way may reduce or eliminate a processing or workflow step employed by the analytic solution generator 210 to format portions of subsequent data submissions. Changes and/or adjustments to characteristics may be based on a variety of factors related to a given analytic solution and/or information submitted and/or used to generate the analytic solutions. In some examples, the changes and/or adjustments to the characteristics are determined based on models, simulations and/or experiments. In some examples, the alert generator 304 generates an alert including a recommendation to change or adjust a characteristic of subsequent data submissions in the given way.

In some examples, the trend determined by the trend determiner 306 includes a trendline or baseline determined based on previous data submissions. For example, if the trend determiner 306 is monitoring values of a biological measurement, the trendline may be an average or range of values included in previous data submissions. For example, the range of values may be determined based on a statistical analysis of values included in previous data submissions. In some examples, the variation determiner 308 compares a characteristic of a data submission to the trendline and determines a way in which the characteristic deviates from the trendline. For example, the variation determiner 308 may determine a difference between the value of a biological measurement from an average value calculated based on previous data submissions. If the characteristic deviates in a predetermined way, the opportunity determiner 302 determines that an opportunity is present to improve a quality of data employed by the healthcare analytics system 104 to generate analytic solutions. For example, if the value of the biological measurement is outside of a predetermined range, the opportunity determiner 302 determines that an opportunity to improve the quality of data is present.

In some examples, the opportunity determiner 302 identifies a source of variability or a data source associated with data submissions that vary or deviate from a trend. Example sources of variability includes an element of a user workflow, a user of the healthcare analytics system 104 (e.g., a clinician), a group of users of the healthcare analytics system 104 (e.g., a plurality of clinicians at a healthcare facility), a medical device in communication with the healthcare analytics system 104 and/or any other user, device and/or source that submits data for use with the healthcare analytics system 104. For example, the opportunity determiner 302 may detect that the data submissions from the third data source 204 vary or deviate from the trend more than or at a higher rate than the other data sources 200, 202, 206. As a result, the example opportunity determiner 302 may identify the third data source 204 as a source of variation and/or recommend a change to a characteristic of data submissions to be input by the third data source 204. In some examples, the opportunity determiner 302 employs analytic tools such as random forest tools, multivariate tools, neural tools, and/or any other analytic tools. In some examples, the opportunity determiner 302 determines a recommendation to enable the characteristic of data submissions to be input via the third data source 204 to substantially match or correspond to the trend. If the recommendation is implemented, the analytic solution may employ higher quality data and, thus, for example, generate more consistent analytic solutions, generate analytic solutions in less time, generate more accurate analytic solutions, etc. In some examples, the alert generator 304 generates an alert including the recommendation or suggestion. In some examples, the alert is displayed via a dashboard generated by the example dashboard service 226 of FIG. 2.

The example data quality determiner 212 may be used to diagnose an issue (e.g., an inconsistency, an error, etc.) in the analytic solution. For example, the data quality determiner 212 may be used to determine if the issue is a result of the workflow of the healthcare analytic system 104 or a result of one or more characteristics of one or more data submissions used to generate the analytic solution. For example, the first data source 200 may be a medical device that provides data submissions into the healthcare analytics system 104, and the analytic solution generator 210 generates analytic solutions (e.g., medical reports) based on the data submissions. If the medical device is subsequently calibrated, a characteristic of subsequent data submissions may change or vary relative to the characteristic of previous data submissions (e.g., data submissions received by the healthcare analytics system 104 prior to the calibration). For example, values of a biological measurement included in the subsequent data submissions may increase relative to previously submitted values. As a result, an error in the analytic solution may occur, but a cause of the error may not be apparent to a user or system viewing and/or employing the analytic solution.

In this example, the trend determiner 306 may trend the values and the variation determiner 308 may detect the increase in the values. In some examples, the opportunity determiner 302 detects an opportunity to improve the quality of data used to generate the analytic solutions if the values deviate from a trendline such as, for example, a range of values. In some examples, the opportunity determiner 302 may detect the opportunity using predetermined logic rules. As a result, the alert generator 304 may generate an alert indicating that the values have changed and including a recommendation to review the calibration of the medical device and/or adjust the workflow of the healthcare analytic system 104 based on the increase in the values. A systems administrator can then determine if the calibration of the medical device was properly performed. If the calibration was properly performed, the systems administrator may adjust the workflow of the healthcare analytic system 104 to resolve the issue. If the calibration was not properly performed, the medical device may be recalibrated. Thus, the example data quality determiner 212 may enable the systems administrator to determine if the data source is causing the issues with the analytic solution or if the workflow is a source of the issues.

Referring back to FIG. 2, the example application 214 may be used to model, simulate and/or evaluate changes to the workflow of the healthcare analytics system 104 recommended by the data quality determiner 212. For example, the application 214 of FIG. 2 employs the example modeling service 218 to enable a systems administrator to model the changes to the workflow and/or design experiments. In the illustrated example, the simulation service 220 generates simulated analytic solutions based on the modeled changes to the workflow to enable the systems administrator to preview and/or evaluate an analytic solution generated using the changes to the workflow without disrupting or interrupting the example healthcare analytics system 104. In some examples, simulations employing predictive capabilities are used to enable the systems administrator to preview and/or evaluate the analytic solution. In some examples, simulation service 220 enables the systems administrator to interact with a simulation by, for example, enabling the systems administrator to fast forward, rewind, select a particular point in time (e.g., via a slider on a graphical interface), freeze a snapshot for review, and/or perform other actions with respect to the simulation. In some examples, the reporting service 224 generates reports that may include, for example, statistics related to the simulated workflow, indications of changes to the analytic solution, and/or other information. In some examples, the modeling service 218 and/or simulation service 220 use previous data submissions employed by the example healthcare analytics system to model and/or simulate the changes to the workflow.

While an example manner of implementing the medical information system 100 of FIG. 1 is illustrated in FIGS. 2-3, one or more of the elements, processes and/or devices illustrated in FIGS. 2-3 may be combined, divided, re-arranged, omitted, eliminated and/or implemented in any other way. Further, the example interface unit 102, the example healthcare analytics system 104, the example data center 106, the example server 18, the example database 110, the example record organizer 112, the example first data source 200, the example second data source 202, the example third data source 204, the example fourth data source 206, the example data ingester 208, the example analytic solution generator 210, the example data quality determiner 212, the example application 214, the example rules service 216, the example modeling service 218, the example simulation service 220, the example algorithm service 222, the example reporting service 224, the example dashboard service 226, the example data submission analyzer 300, the example opportunity determiner 302, the example alert generator 304, the example trend determiner 306, the example variation determiner 308, the example KPI determiner 310, and/or, more generally, the example medical information system 100 of FIG. 1 may be implemented by hardware, software, firmware and/or any combination of hardware, software and/or firmware. Thus, for example, any of the example interface unit 102, the example healthcare analytics system 104, the example data center 106, the example server 18, the example database 110, the example record organizer 112, the example first data source 200, the example second data source 202, the example third data source 204, the example fourth data source 206, the example data ingester 208, the example analytic solution generator 210, the example data quality determiner 212, the example application 214, the example rules service 216, the example modeling service 218, the example simulation service 220, the example algorithm service 222, the example reporting service 224, the example dashboard service 226, the example data submission analyzer 300, the example opportunity determiner 302, the example alert generator 304, the example trend determiner 306, the example variation determiner 308, the example KPI determiner 310, and/or, more generally, the example medical information system 100 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, interface unit 102, the example healthcare analytics system 104, the example data center 106, the example server 18, the example database 110, the example record organizer 112, the example first data source 200, the example second data source 202, the example third data source 204, the example fourth data source 206, the example data ingester 208, the example analytic solution generator 210, the example data quality determiner 212, the example application 214, the example rules service 216, the example modeling service 218, the example simulation service 220, the example algorithm service 222, the example reporting service 224, the example dashboard service 226, the example data submission analyzer 300, the example opportunity determiner 302, the example alert generator 304, the example trend determiner 306, the example variation determiner 308, the example KPI determiner 310, and/or, more generally, the example medical information system 100 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example medical information system 100 may include one or more elements, processes and/or devices in addition to, or instead of, those illustrated in FIG. 1, and/or may include more than one of any or all of the illustrated elements, processes and devices.

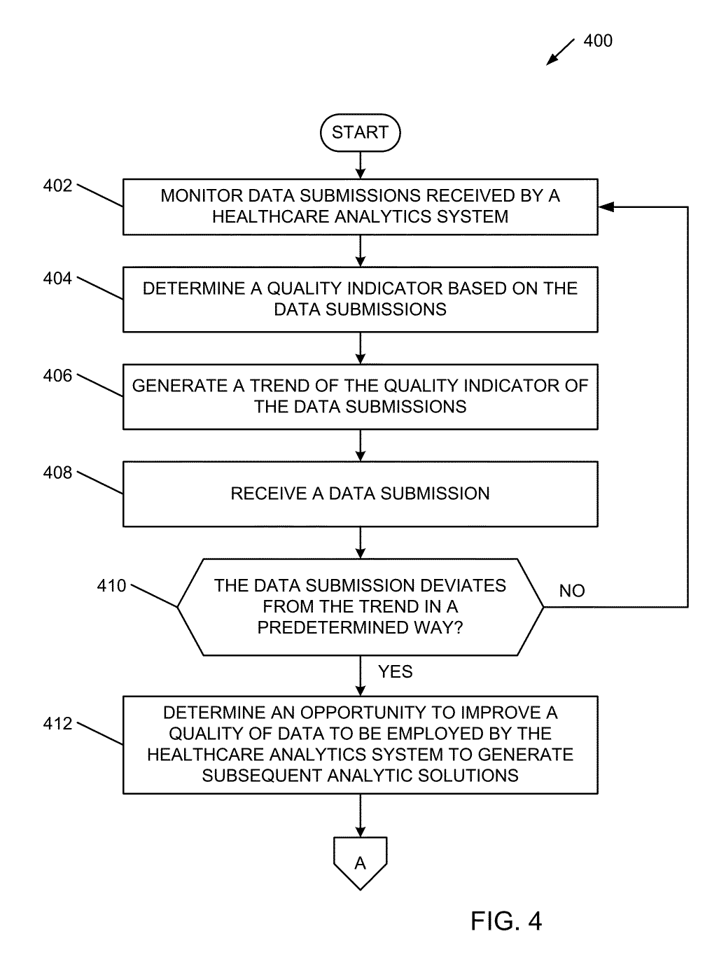

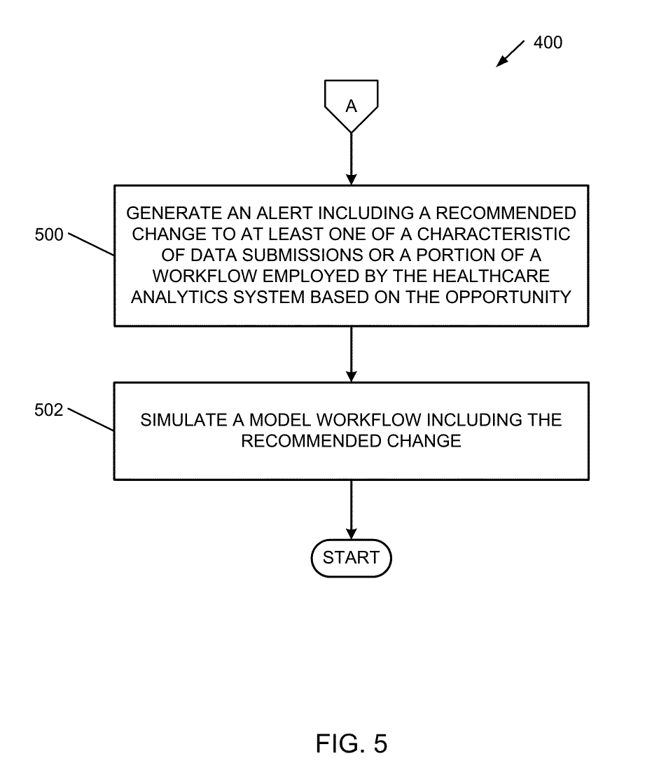

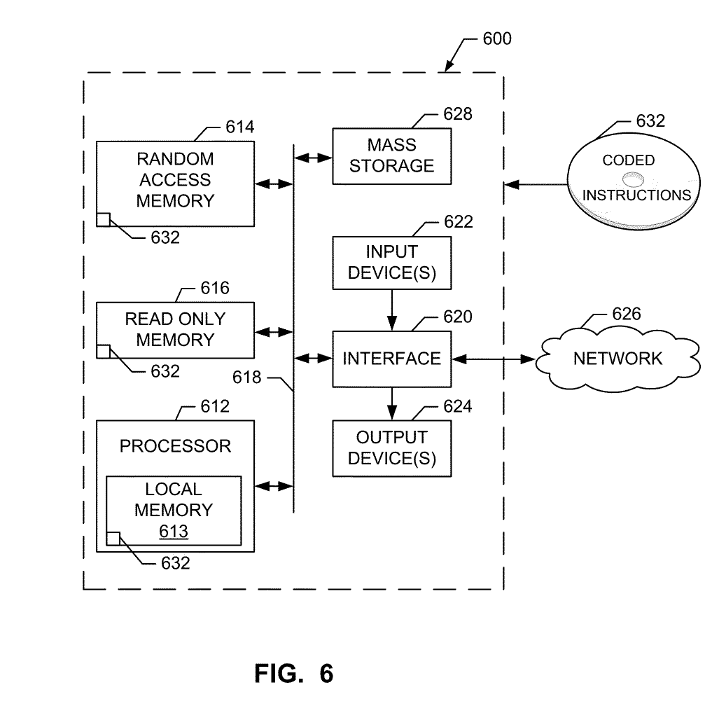

A flowchart representative of example machine readable instructions for implementing the example healthcare analytic system 104 is shown in FIGS. 4-5. In this example, the machine readable instructions comprise a program for execution by a processor such as the processor 612 shown in the example processor platform 600 discussed below in connection with FIG. 6. The program may be embodied in software stored on a tangible computer readable storage medium such as a CD-ROM, a floppy disk, a hard drive, a digital versatile disk (DVD), a Blu-ray disk, or a memory associated with the processor 612, but the entire program and/or parts thereof could alternatively be executed by a device other than the processor 612 and/or embodied in firmware or dedicated hardware. Further, although the example program is described with reference to the flowchart illustrated in FIGS. 4-5, many other methods of implementing the example healthcare analytics system 104 may alternatively be used. For example, the order of execution of the blocks may be changed, and/or some of the blocks described may be changed, eliminated, or combined.

As mentioned above, the example processes of FIGS. 4-5 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 4-5 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

Although the following examples are described in conjunction with the example medical information system 100 of FIGS. 1-3, the example method 400 may be used in conjunction with other information systems. FIG. 4 illustrates a flow diagram of an example method 400 to improve a quality of data employed to generate an analytic solution. At block 402, data submissions received by the healthcare analytics system 104 are monitored. For example, the data quality determiner 212 may monitor and/or log a plurality of characteristics of the data submissions.

At block 404, a quality indicator is determined based on the data submissions. In some examples, the quality indicator is a characteristic of the data submissions. For example, the KPI determiner 310 may determine which ones of the plurality of characteristics to monitor and/or trend by comparing data submissions received by the healthcare analytic system 104 with data ingested and/or used by the healthcare analytic system 104 to generate analytic solutions. In some examples, if a portion of a data submission is filtered, discarded, rejected, formatted and/or not used, the KPI determiner 310 may determine that the quality indicator is a characteristic of the data submissions that causes or triggers the healthcare analytic system 104 to filter, discard, reject, format and/or not use the portion of the data submission. In some examples, the KPI determiner 310 determines the quality indicator based on or more variations or consistencies between the data submissions. For example, if a characteristic of the data submissions is substantially similar, the KPI determiner 310 may determine that the characteristic is the quality indicator. In other examples, the KPI determiner 310 determines that the quality indicator is a characteristic that varies between the data submissions. In other example, the quality indicator is determined in other ways.

At block 406, a trend of the quality indicator is generated. For example, the trend determiner 306 may generate a trendline of the quality indicator of previous data submissions using a statistical analysis. At block 408, a data submission is received. At block 410, it is determined if the data submission deviates from the trend in a predetermined way. For example, the opportunity determiner 302 may determine if the quality indicator of the data submission deviates from the trendline in a predetermined way. For example, if the quality indicator is a value, the opportunity determiner 302 may determine that the quality indicator of the data submission deviates from the trendline in the predetermine way if the quality indicator exceeds a threshold variation (e.g., a difference) from a value corresponding to the trendline. If the data submission does not deviate from the trend in the predetermined way, the example method 400 returns to block 402.

If the data submission deviates from the trend in the predetermined way, an opportunity to improve a quality of data to be employed by the healthcare analytics system 104 to generate subsequent analytic solutions is determined. In some examples, the opportunity determiner 302 determines the opportunity is a change to the quality indicator for data submissions. For example, if the quality indicator is capitalization of a first letter of a word included in the previous data submissions, the opportunity determiner 302 may determine that subsequent data submissions that include capitalized first letters would improve the quality of data employed by the healthcare analytics system 104 to generate subsequent analytic solutions. In some examples, the opportunity determiner 302 determines the opportunity is a change in a workflow employed by the healthcare analytics system 104 to generate the analytic solutions.

In some examples, the variation determiner 308 identifies a data source that input the data submission. For example, the variation determiner 308 may determine that the data submission that deviated from the trendline in the predetermined way was input via a user workstation associated with, for example, a clinician, a group of users, a medical center, and/or any other data source.

Referring to FIG. 5, the example method 400 continues at block 500 by generating an alert including a recommended change to at least one of a characteristic of data submissions or a portion of a workflow employed by the healthcare analytics system 104 based on the opportunity. In some examples, the recommended change to the characteristic of the data submissions is a recommended change to the quality indicator. In some examples, the recommended change to the portion of the workflow is to enable the workflow to generate more consistent and/or accurate analytical solutions. In some examples, the recommended change to the portion of the workflow is to enable to the workflow to generate the analytical solutions in a different and/or more efficient way (e.g., by discarding, formatting, manipulating less data included in data submissions).

At block 502, a model workflow including the recommended change is simulated. For example, a user of the example healthcare analytics system 104 may use the application 214 to generate a model workflow including the change and then simulate the model workflow to generate an analytic solution. The user may then view and/or analyze to the analytic solution generated via the model workflow to evaluate the change. If the user accepts the change, the application 214 may update or adjust the workflow of the healthcare analytics system 104. In some examples, in response to receiving a selection from the user, the healthcare analytics system 104 adjusts the workflow to include the recommended change and resets the trend. For example, the healthcare analytics system 104 may generate a trend using only data submissions received after the workflow is adjusted.

FIG. 6 is a block diagram of an example processor platform 600 capable of executing the instructions of FIGS. 4-5 to implement the example healthcare analytics system 104 of FIGS. 1-3. The processor platform 600 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 600 of the illustrated example includes a processor 612. The processor 612 of the illustrated example is hardware. For example, the processor 612 can be implemented by one or more integrated circuits, logic circuits, microprocessors or controllers from any desired family or manufacturer.

The processor 612 of the illustrated example includes a local memory 613 (e.g., a cache). The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is controlled by a memory controller.

The processor platform 600 of the illustrated example also includes an interface circuit 620. The interface circuit 620 may be implemented by any type of interface standard, such as an Ethernet interface, a universal serial bus (USB), and/or a PCI express interface.

In the illustrated example, one or more input devices 622 are connected to the interface circuit 620. The input device(s) 622 permit(s) a user to enter data and commands into the processor 612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 624 are also connected to the interface circuit 620 of the illustrated example. The output devices 624 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 620 of the illustrated example, thus, typically includes a graphics driver card, a graphics driver chip or a graphics driver processor.

The interface circuit 620 of the illustrated example also includes a communication device such as a transmitter, a receiver, a transceiver, a modem and/or network interface card to facilitate exchange of data with external machines (e.g., computing devices of any kind) via a network 626 (e.g., an Ethernet connection, a digital subscriber line (DSL), a telephone line, coaxial cable, a cellular telephone system, etc.).

The processor platform 600 of the illustrated example also includes one or more mass storage devices 628 for storing software and/or data. Examples of such mass storage devices 628 include floppy disk drives, hard drive disks, compact disk drives, Blu-ray disk drives, RAID systems, and digital versatile disk (DVD) drives.

The coded instructions 632 of FIGS. 4-5 may be stored in the mass storage device 628, in the volatile memory 614, in the non-volatile memory 616, and/or on a removable tangible computer readable storage medium such as a CD or DVD.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method, comprising:
receiving a data submission in a healthcare analytics system, the healthcare analytics system to generate an analytic solution based on the data submission;
determining, by the healthcare analytics system, an opportunity to improve a quality of data to be employed by the healthcare analytics system to generate the analytic solution based on a trend of previously received data submissions and the data submission; and
generating an alert including a recommended change to at least one of a characteristic of the data submission or a portion of a workflow of the healthcare analytics system based on the opportunity.

2. The method of claim 1 further comprising generating the trend of the previously received data submissions.

3. The method of claim 2 wherein generating the trend comprises determining which one of a plurality of characteristics of the previously received data submissions is to be trended.

4. The method of claim 3, wherein determining which one of the plurality of characteristics is to be trended comprises determining variations between previously rejected data submissions and data submissions previously used to generate the analytic solution.

5. The method of claim 2, wherein determining the opportunity to improve the quality of the data to be received comprises determining a variation between the data submission and the trend.

6. The method of claim 5, wherein determining the opportunity to improve the quality of the data to be received further comprises determining if the variation exceeds a threshold variation.

7. The method of claim 1 further comprising:
determining an error in the analytic solution; and
determining if the error is caused by the characteristic of the data submission or the portion of the workflow.

8. The method of claim 1, wherein determining the opportunity to improve the quality of the data comprises determining if a portion of the data submission is at least one of rejected, unused or formatted by the healthcare analytics system.

9. A method, comprising:
monitoring data submissions received by a healthcare analytics system, the healthcare analytics system to generate an analytic solution based on the data submissions;
determining a trend of the data submissions;
receiving a data submission via the healthcare analytics system;
comparing the data submission to the trend; and
generating an alert if the data submission deviates from the trend in a predetermined way, the alert including a recommended change to a characteristic of subsequent data submissions.

10. The method of claim 9, wherein generating the alert comprises logging a deviation between the data submission and the trend.

11. The method of claim 9, wherein the predetermined way comprises a deviation in at least one of format, style, or content.

12. The method of claim 9 further comprising determining a source of variability of the data submission based on the data submissions and the trend.

13. The method of claim 12, wherein the source of variability comprises at least one of an element of a user workflow, a user of the healthcare analytics system, a group of users of the healthcare analytics system, or a medical device in communication with the healthcare analytics system.

14. The method of claim 9 further comprising generating a model workflow for the healthcare analytics system to enable a user to preview an effect of the recommended change on the analytic solution.

15. A method, comprising:
monitoring data submissions ingested by a healthcare analytics system, the healthcare analytics system to generate an analytic solution based on the data submissions;
determining a quality indicator based on the data submissions;
generating a trend of the quality indicator of the data submissions;
receiving a data submission;
determining if the data submission deviates from the trend in a predetermined way; and
generating an alert if the data submission deviates from the trend in a predetermined way, the alert including at least one of a first recommendation to enable subsequent data submissions to substantially correspond to the trend or a second recommendation to adjust a portion of a workflow of the healthcare analytics system.

16. The method of claim 15, wherein the quality indicator is a characteristic of at least one of formatting, style, or content of the data submissions.

17. The method of claim 15, wherein determining the quality indicator comprises determining at least one of variations or consistencies between the data submissions.

18. The method of claim 15 further comprising receiving a selection of the second recommendation and resetting the trend based on the data submission.

19. The method of claim 15, wherein the first recommendation includes a recommended characteristic to be employed in subsequent data submissions to at least one of reduce, minimize or eliminate a deviation of the subsequent data submissions from the trend.

20. The method of claim 15, wherein the healthcare analytics system generates the analytic solution via a workflow, and further comprising receiving a selection of the second recommendation and adjusting the portion of the workflow.
